(19) United States
(12) Patent Application Publication
(10) Pub. No.: US 2004/0071837 A1
(43) Pub. Date: Apr. 15, 2004

(54) Multi-layered, biaxially-oriented, sealable tubular film for the packaging and wrapping of meat, meat with bones and paste-like foodstuff and use thereof

(76) Inventors: Hartmut Grund, Otterstadt (DE); Horst Lang, Weinheim (DE)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/466,772

(22) PCT Filed: Feb. 1, 2001
(86) PCT No.: PCT/EP01/01066

(51) Int. Cl. C12C 1/027

(52) U.S. Cl. 426/106

(57) ABSTRACT

The invention relates to a multilayered, biaxially oriented, shrinkable and sealable tubular film for the packaging and wrapping of meat, meat with bones, and paste-like foodstuffs and to the use thereof. The inventive, preferably five-layered, tubular film has an inner layer comprised of at least one copolyamide and at least one amorphous polyamide and/or at least one homopolyamide and/or at least one modified polyolefin, a middle polyolefin layer, and an outer layer comprised of at least one homopolyamide and/or at least one copolyamide and/or at least one copolymer of ethylene-vinyl alcohol and/or a modified polyolefin. Two adhesion-promoting layers are situated between the inner layer and middle layer and between the middle layer and outer layer. The film according to the invention has significantly increased seal seam strength even at low sealing temperatures and high resistance to puncturing.

The invention relates to a multilayered, biaxially oriented, shrinkable, sealable tubular film and to its use for the packaging and wrapping of meat, meat with bones, and paste-like foodstuffs.

A five-layered, polyamide-based tubular film for packaging and wrapping pasty foodstuffs, especially a sausage skin, is already known from DE 43 39 337 C2. This tubular film is comprised of an inner layer and an outer layer made of the same polyamide material, a middle polyolefin layer and two adhesion-promoting layers made of the same material and situated between the inner layer and middle layer and between the middle layer and outer layer. The inner and outer layers consist of at least one aliphatic polyamide and/or at least one aliphatic copolyamide and at least one partially aromatic polyamide and/or at least one partially aromatic copolyamide, the amount of partially aromatic polyamide and/or copolyamide being from 5 to 60 wt.- %, relative to the total weight of the polymer mixture of partially aromatic and aliphatic polyamides and copolyamides. Such a tubular film, produced by coextrusion, is provided with controlled shrinkability by biaxial stretching and heat-setting. With respect to its technological properties important to wrapping and packaging of meat, especially meat with bones, such a tubular film requires some improvements. In the event of meat with bones there is a risk of protruding bones piercing the packaging film following shrinking of the packaging film on the packaged item, because the puncture resistance is insufficient. Furthermore, such tubular films for packaging and wrapping meat or meat with bones and pasty foodstuffs should also allow sealing by simple heat-sealing. With bags produced using such tubular films, the strength of the seal seam is a crucial issue. For example, when a piece of ham or meat drops out of a spout and into a bag made of a plastic film and sealed at its bottom by a heat-seal seam, considerable loads—depending on the weight—arise due to the product to be packaged dropping into the bag, possibly giving rise to tearing of the heat-seal seam and complete opening of the bag at the bottom thereof. Also, the heat-seal seam is exposed to extreme load during subsequent vacuum treatment and shrinking of the bags. Likewise, shipment and storage of the filled bags involve high demands on the puncture resistance of the film and on the seal seam strength.

The object of the present invention is therefore to provide a biaxially oriented, shrinkable, sealable tubular film for the packaging and wrapping of meat, meat with bones, and paste-like foodstuffs which, in addition to the requirements to be met by such a packaging film, such as low water vapor and oxygen permeabilities, firstly has high puncture resistance of the tubular film and secondly high strength of the seal seam.

Said object is accomplished by means of a multilayered, biaxially oriented, shrinkable, sealable tubular film having the characterizing features of claim 1.

The inner layer includes at least one sealable copolyamide. These per se known copolyamides are produced from monomers selected from the group of caprolactam, laurinlactam, ω-aminoundecanoic acid, adipic acid, azelaic acid, sebacic acid, decanedicarboxylic acid, dodecanedicarboxylic acid, terephthalic acid, isophthalic acid, tetramethylenediamine, pentamethylenediamine, hexamethylenediamine, octamethylenediamine, and xylylenediamine. The wall thickness of the inner layer is between 5 and 16 μm.

Surprisingly, addition of an amorphous polyamide and/or of a homopolyamide and/or of a modified polyolefin to a copolyamide in the inner layer significantly increases the strength of the seal seam compared to pure copolyamide, and high seal seam strength is achieved even at low sealing temperatures. Consequently, the film of the invention presents considerable technological advantages.

Polyamides having a glass transition temperature between 50 and 200° C. in dry state are used as amorphous polyamides for the inner layer. Examples are polyamide 6I/6T, polyamide 6-3-T and polyamide 6I.

Polyamides which can be produced from the same monomers as the copolyamides described above are used as homopolyamides for the inner layer. The homopolyamides can be both aliphatic and partially aromatic in character.

The modified polyolefins for the inner layer are copolymers of ethylene or propylene and optionally other linear α-olefins having from 3 to 8 C atoms and α,β-unsaturated carboxylic acids, preferably acrylic acid, methacrylic acid and/or metal salts and/or alkyl esters thereof, or appropriate graft copolymers of the above-mentioned monomers on polyolefins, or partially saponified ethylene-vinyl acetate copolymers which are optionally graft-polymerized with an α,β-unsaturated carboxylic acid and have a low saponification level, or mixtures thereof. Furthermore, the modified polyolefins can be modified homo- or copolymers of ethylene and/or propylene and optionally other linear α-olefins having from 3 to 8 C atoms, which have monomers from the group of α,β-unsaturated dicarboxylic acids, preferably maleic acid, fumaric acid, itaconic acid, or anhydrides, esters, amides or imides thereof grafted thereon.

The major component of the inner layer is a sealable copolyamide or a mixture of sealable copolyamides, said major component being present in amounts of between 50 and 95 wt.- %. Each of the other components, amorphous polyamide and/or homopolyamide and/or modified polyolefin, can be admixed to the major component in amounts of from 1 to 30 wt.- %, preferably from 5 to 25 wt.- %, relative to the overall inner layer.

The two adhesion-promoting layers preferably have the same composition and consist of polyolefins modified with functional groups. Such modified polyolefins are modified homo-or copolymers of ethylene and/or propylene and optionally other linear α-olefins having from 3 to 8 C atoms, which have monomers from the group of α,β-unsaturated dicarboxylic acids such as maleic acid, fumaric acid, itaconic acid, or anhydrides, esters, amides or imides thereof grafted thereon. The wall thickness of each adhesion-promoting layer is between 3 and 10 μm.

A polyolefin layer preferably constituted of homopolymers of ethylene or propylene and/or copolymers of linear α-olefins having from 2 to 8 C atoms is used as middle layer in the wrapping according to the invention. Linear low-density polyethylene, high-density polyethylene, polypropylene homopolymer, polypropylene block copolymer and polypropylene random copolymer are preferably used for the middle layer. The wall thickness wall of this layer is between 6 and 22 μm.

Various materials can be used for the outer layer, namely, homopolyamides, alone or in mixture, copolyamides, alone or in mixture, or mixtures of homo- and copolyamides. In addition, the outer layer may also include copolymers of ethylene and vinyl alcohol and/or modified polyolefins. The wall thickness wall of the outer layer is between 12 and 43 μm.

Suitable homo- and copolyamides are well-known and can be produced from the corresponding monomers such as caprolactam, laurinlactam, ω-aminoundecanoic acid, adipic acid, azelaic acid, sebacic acid, decanedicarboxylic acid, dodecanedicarboxylic acid, terephthalic acid, isophthalic acid, tetramethylenediamine, pentamethylenediamine, hexamethylenediamine, octamethylenediamine, and xylylenediamine.

Preferred homo- and copolyamides are polyamide 6, polyamide 12, polyamide 610, polyamide 612, polyamide MXD6, polyamide 6/66, polyamide 6/12, polyamide 6I/6T.

The copolymers of ethylene and vinyl alcohol are produced by complete saponification of copolymers of ethylene and vinyl acetate. In general, the amount of ethylene in the ethylene-vinyl alcohol copolymers is between 27 and 48 mole- %. For addition in the outer layer, ethylene-vinyl alcohol copolymers are preferred wherein the amount of ethylene is between 27 and 38 mole- %.

The modified polyolefins are copolymers of ethylene or propylene and optionally other linear α-olefins having from 3 to 8 C atoms and α,β-unsaturated carboxylic acids, preferably acrylic acid, methacrylic acid and/or metal salts and/or alkyl esters thereof, or appropriate graft copolymers of the above-mentioned monomers on polyolefins, or partially saponified ethylene-vinyl acetate copolymers which are optionally graft-polymerized with an α,β-unsaturated carboxylic acid and have a low saponification level, or mixtures thereof. Furthermore, the modified polyolefins can be modified homo- or copolymers of ethylene and/or propylene and optionally other linear α-olefins having from 3 to 8 C atoms, which have monomers from the group of α,β-unsaturated dicarboxylic acids, preferably maleic acid, fumaric acid, itaconic acid, or anhydrides, esters, amides or imides thereof grafted thereon.

The major component of the outer layer is comprised of homopolyamides, alone or in mixture, copolyamides, alone or in mixture, or of mixtures of homo- and copolyamides, said major component being present in amounts of between 50 and 100 wt.- %. Where additional components such as copolymers of ethylene and vinyl alcohol and/or modified polyolefins are present, each one is admixed to the major component in amounts of from 0 to 40 wt.- %, relative to the overall outer layer.

In addition, conventional auxiliary agents such as anti-blocking agents, stabilizers, antistatic agents or lubricants can be included in the tubular film. These auxiliary agents are normally added in amounts of from 0.1 to 5 wt.- %. Furthermore, the film can be colored by adding pigments or pigment mixtures.

The tubular films of the invention are produced by coextrusion wherein the individual polymers for the separate layers are plastified and homogenized in five extruders, and the five melt streams, according to the desired single wall thickness ratios, are subsequently extruded through a five-layer extrusion head to form a primary tube and subjected to biaxial stretching and heat-setting.

The tubular films of the invention have an overall wall thickness of from 30 to 100 μm, preferably from 50 to 90 μm.

Surprisingly, the tubular films of the invention are clearly superior to the tubular films of DE 43 39 337 C2 both with respect to seal seam strength and puncture resistance.

To determine the seal seam strength, each tubular film was welded inside at a right angle to the machine direction, using an SGPE 20 laboratory welding apparatus from W. Kopp Verpackungsmaschinen. Strips 25 mm in width were taken from the welded tubular films in such a way that the welding seam was at a right angle to the length of the strip. The strip samples were stretched on a tensile testing machine from Instron Company at a stretching rate of 500 mm/min until breaking of the weld seam occurred. The resulting maximum force will be referred to as seal seam strength hereinafter.

As a measure for the puncture resistance, the damaging energy is determined in a penetration test.

The damaging energy was determined following DIN 53373, but deviating from said DIN standard, a hardened cylindrical form A pin 3 mm in diameter, according to DIN EN 28 734, was used as impact body and the testing rate was 500 mm/min. The damaging energy is the- energy that is absorbed until initial tearing of the sample occurs.

The tubular film according to DE 43 39 337 C2 (Comparative Example 1) could not be welded at sealing temperatures of 140 and 200° C., while the tubular films of the invention achieved satisfactory to good seal seam strength already at a sealing temperature of 140° C. At a sealing temperature of 200° C., the tubular films of the invention exhibit seal seam strengths which are at least 15% higher than those of the Comparative Examples.

The tubular films according to the invention exhibit slightly to significantly higher damaging energy values in the penetration test as well.

The invention will be illustrated in more detail with reference to the following examples.

### EXAMPLE 1

The individual polymers for the separate layers were plastified and homogenized in five extruders. According to the desired single wall thickness ratios, the five melt streams were fed into a five-layer extrusion head, formed into a primary tube and subjected to biaxial stretching and heat-setting. The primary tube had a diameter of 45.5 mm and a mean overall wall thickness of 0.49 mm. It was heated to 109° C. using infrared radiation and stretched at a surface stretch ratio of 9.7. The biaxially stretched tube was heat-set, flattened, and wound up. The mean overall wall thickness of the tube was 50 μm, and the flat width was 209 mm.

The layers of the final tube consisted of the following polymers, with a single wall thickness as indicated:

| | |
|---|---|
| 1^{st} layer (outer | Polyamide 6, Ultramid B4 F from BASF AG, 20 μm |
| layer): | |
| 2^{nd} layer: | Adhesion promotor, modified polyethylene, Admer |
| | NF 478 E from Mitsui Chemicals Inc., 5 μm |
| 3^{rd} layer: | Polyethylene (LDPE), Lupolen 1804H from BASF AG, |
| | 10 μm |
| 4^{th} layer: | Adhesion promotor (as in layer 2), 5 μm |
| 5^{th} layer (inner | Blend of 90% polyamide 6/12, Grilon CF6S from EMS |
| layer): | Chemie and 10% polyamide 12, UBE Nylon 3030 B |
| | from UBE Industries Ltd., 10 μm |

The following seal seam strength values were determined:

Sealing temperature 140° C.: 7 N/25 mm

Sealing temperature 200° C.: 95 N/25 mm

The damaging energy was 380 mJ.

### EXAMPLE 2

The individual polymers for the separate layers were plastified and homogenized in five extruders. According to the desired single wall thickness ratios, the five melt streams were fed into a five-layer extrusion head, formed into a primary tube and subjected to biaxial stretching and heat-setting. The primary tube had a diameter of 45.5 mm and a mean overall wall thickness of 0.48 mm. It was heated to 108° C. using infrared radiation and stretched at a surface stretch ratio of 9.6. The biaxially stretched tube was heat-set, flattened, and wound up. The mean overall wall thickness of the tube was 50 μm, and the flat width was 209 mm.

The layers of the final tube consisted of the following polymers, with a single wall thickness as indicated:

| | |
|---|---|
| 1^{st} layer (outer | Polyamide 6/66, Ultramid C35 from BASF AG, 18 μm |
| layer): | |
| 2^{nd} layer: | Adhesion promotor, modified polyethylene, Admer |
| | NF 478 E from Mitsui Chemicals Inc., 6 μm |
| 3^{rd} layer: | Polyethylene (LDPE), Lupolen 1804H from BASF AG, |
| | 10 μm |
| 4^{th} layer: | Adhesion promotor (as in layer 2), 6 μm |
| 5^{th} layer (inner | Blend of 90% polyamide 6/12, Grilon CF6S from EMS |
| layer): | Chemie and 10% ionomer resin, Surlyn 1652 from Du |
| | Pont de Nemours GmbH, 10 μm |

The following seal seam strength values were determined:

Sealing temperature 140° C.: 75 N/25 mm

Sealing temperature 200° C.: 93 N/25 mm

The damaging energy was 455 mJ.

### EXAMPLE 3

The individual polymers for the separate layers were plastified and homogenized in five extruders. According to the desired single wall thickness ratios, the five melt streams were fed into a five-layer extrusion head, formed into a primary tube and subjected to biaxial stretching and heat-setting. The primary tube had a diameter of 45.5 mm and a mean overall wall thickness of 0.50 mm. It was heated to 109° C. using infrared radiation and stretched at a surface stretch ratio of 10.0. The biaxially stretched tube was heat-set, flattened, and wound up. The mean overall wall thickness of the tube was 50 μm, and the flat width was 210 mm.

The layers of the final tube consisted of the following polymers, with a single wall thickness as indicated:

| | |
|---|---|
| 1^{st} layer (outer | Polyamide 6/66, Ultramid C35 from BASF AG, 20 μm |
| layer): | |
| 2^{nd} layer: | Adhesion promotor, modified polyethylene, Admer |
| | NF 478 E from Mitsui Chemicals Inc., 5 μm |
| 3^{rd} layer: | Polyethylene (LLDPE), Dowlex 2049 E from DOW |
| | Chemical Company, 10 μm |
| 4^{th} layer: | Adhesion promotor (as in layer 2), 6 μm |
| 5^{th} layer (inner | Blend of 85% polyamide 6/12, Grilon CF6S from EMS |
| layer): | Chemie and 5% polyamide 6I/6T, Grivory G21 from |
| | EMS Chemie and 10% ionomer resin, Surlyn 1652 from |
| | Du Pont de Nemours GmbH, 9 μm |

The following seal seam strength values were determined:

Sealing temperature 140° C.: 12 N/25 mm

Sealing temperature 200° C.: 96 N/25 mm

The damaging energy was 460 mJ.

### COMPARATIVE EXAMPLE 1

A five-layered tubular film with the following structure was produced according to DE 43 39 337 C2:

| | |
|---|---|
| 1^{st} layer (outer | Blend of 95% polyamide 6, Durethan B40 F from Bayer |
| layer): | AG and 5% polyamide 6I/6T, Grivory G21 from EMS |
| | Chemie, 20 μm |
| 2^{nd} layer: | Adhesion promotor, modified polyethylene, Admer |
| | NF 478 E from Mitsui Chemicals Inc., 4 μm |
| 3^{rd} layer: | Polyethylene (LLDPE), Dowlex 2049 E from DOW |
| | Chemical Company, 14 μm |
| 4^{th} layer: | Adhesion promotor (as in layer 2), 4 μm |
| 5^{th} layer (inner | Blend of 95% polyamide 6, Durethan B40 F from |
| layer): | Bayer AG and 5% polyamide 6I/6T, Grivory G21 from |
| | EMS Chemie, 8 μm |

The following seal seam strength values were determined:

Sealing temperature 140° C.: no welding

Sealing temperature 200° C.: no welding

The damaging energy was 315 mJ.

### COMPARATIVE EXAMPLE 2

A five-layered tubular film was produced as in Example 1, with the exception that the fifth layer (inner layer) consisted of pure polyamide 6/12, Grilon CF6S from EMS Chemie.

The following seal seam strength values were determined:

Sealing temperature 140° C.: 35 N/25 mm

Sealing temperature 200° C.: 81 N/25 mm

The damaging energy was 375 mJ.

1. A multilayered, preferably five-layered, biaxially oriented, shrinkable, sealable tubular film for the packaging and wrapping of meat, meat with bones, or paste-like foodstuffs, characterized in that the tubular film is constituted of an inner layer comprised of at least one copolyamide and at least one amorphous polyamide and/or at least one homopolyamide and/or at least one modified polyolefin, a middle polyolefin layer, and an outer layer comprised of at least one homopolyamide and/or at least one copolyamide and/or at least one copolymer of ethylene-vinyl alcohol and/or a modified polyolefin, and two adhesion-promoting layers which preferably consist of the same material and are situated between the inner layer and middle layer and between the middle layer and outer layer.

2. The tubular film according to claim 1, characterized in that the inner layer includes copolyamides produced from monomers selected from the group of caprolactam, laurinlactam, ω-aminoundecanoic acid, adipic acid, azelaic acid, sebacic acid, decanedicarboxylic acid, dodecanedicarboxylic acid, terephthalic acid, isophthalic acid, tetramethylenediamine, pentamethylenediamine, hexamethylenediamine, octamethylenediamine, and xylylenediamine.

3. The tubular film according to claim 2, characterized in that the copolyamides in the inner layer are present in amounts of from 50 to 95 wt.- %.

4. The tubular film according to any of claims 1 to 3, characterized in that the inner layer includes amorphous polyamides having a glass transition temperature between 50 and 200° C. in dry state.

5. The tubular film according to claim 4, characterized in that the glass transition temperature of the amorphous polyamides is preferably between 90 and 160° C.

6. The tubular film according to any of claims 1 to 5, characterized in that the inner layer includes homopolyamides produced from monomers selected from the group of caprolactam, laurinlactam, ω-aminoundecanoic acid, adipic acid, azelaic acid, sebacic acid, decanedicarboxylic acid, dodecanedicarboxylic acid, terephthalic acid, isophthalic acid, tetramethylenediamine, pentamethylenediamine, hexamethylenediamine, octamethylenediamine, and xylylenediamine.

7. The tubular film according to any of claims 1 to 6, characterized in that the inner layer includes modified polyolefins, which polyolefins are copolymers of ethylene or propylene and optionally other linear α-olefins having from 3 to 8 C atoms and α,β-unsaturated carboxylic acids, preferably acrylic acid, methacrylic acid and/or metal salts and/or alkyl esters thereof, or appropriate graft copolymers of the above-mentioned monomers on polyolefins, or partially saponified ethylene-vinyl acetate copolymers which are optionally graft-polymerized with an α,β-unsaturated carboxylic acid and have a low saponification level, or mixtures thereof.

8. The tubular film according to claims 1 to 7, characterized in that each of the other components included in the inner layer, amorphous polyamide, homopolyamide and modified polyolefin, can be admixed in amounts of from 1 to 30 wt.- %, preferably from 5 to 25 wt.- %, relative to the overall inner layer.

9. The tubular film according to any of claims 1 to 8, characterized in that the polyolefin middle layer is constituted of homopolymers of ethylene or propylene and/or of copolymers of linear α-olefins having from 2 to 8 C atoms.

10. The tubular film according to claim 9, characterized in that the polyolefins of the middle layer are preferably comprised of linear low-density polyethylene, high-density polyethylene, polypropylene homopolymers, polypropylene block copolymers and polypropylene random copolymers.

11. The tubular film according to any of claims 1 to 10, characterized in that the two adhesion-promoting layers are comprised of polyolefins modified with functional groups.

12. The tubular film according to claim 11, characterized in that the modified polyolefins are modified homo- or copolymers of ethylene and/or propylene and optionally other linear α-olefins having from 3 to 8 C atoms, which have monomers from the group of α,β-unsaturated dicarboxylic acids such as maleic acid, fumaric acid, itaconic acid, or anhydrides, esters, amides or imides thereof grafted thereon.

13. The tubular film according to claim 11, characterized in that the modified polyolefins of the two adhesion-promoting layers are copolymers of ethylene or propylene and optionally other linear α-olefins having from 3 to 8 C atoms and α,β-unsaturated carboxylic acids such as acrylic acid, methacrylic acid and/or metal salts and/or alkyl esters thereof, or appropriate graft copolymers of the above-mentioned monomers on polyolefins, or partially saponified ethylene-vinyl acetate copolymers which are optionally graft-polymerized with an α,β-unsaturated carboxylic acid and have a low saponification level, or mixtures thereof.

14. The tubular film according to any of claims 1 to 13, characterized in that the outer layer consists of a mixture of at least one homopolyamide and/or one copolyamide which are produced from monomers selected from the group of caprolactam, laurinlactam, ω-aminoundecanoic acid, adipic acid, azelaic acid, sebacic acid, decanedicarboxylic acid, dodecanedicarboxylic acid, terephthalic acid, isophthalic acid, tetramethylenediamine, pentamethylenediamine, hexamethylenediamine, octamethylenediamine, and xylylenediamine.

15. The tubular film according to claim 14, characterized in that the outer layer, in addition to homopolyamide and/or copolyamide, includes a modified polyolefin produced by copolymerization of ethylene or propylene and optionally other linear α-olefins having from 3 to 8 C atoms and α,β-unsaturated carboxylic acids such as acrylic acid, methacrylic acid and/or metal salts and/or alkyl esters thereof, or appropriate graft copolymers of the above-mentioned monomers on polyolefins, or partially saponified ethylene-vinyl acetate copolymers which are optionally graft-polymerized with an α,β-unsaturated carboxylic acid and have a low saponification level, or mixtures thereof.

16. The tubular film according to claim 14, characterized in that the outer layer, in addition to homopolyamide and/or copolyamide, includes a copolymer of ethylene-vinyl alcohol, the amount of ethylene in the ethylene vinyl alcohol copolymer being between 27 and 48 mole- %, preferably between 27 and 38 mole- %.

17. The tubular film according to claims 14 to 16, characterized in that the amount of modified polyolefin and/or ethylene-vinyl alcohol copolymer is from 0 to 40 wt.- %, relative to the overall outer layer.

18. The tubular film according to any of claims 1 to 17, characterized in that the tubular film consists of a coextruded and biaxially stretched tubular film which has been subjected to heat-setting.

19. The tubular film according to any of claims 1 to 18, characterized in that the wall thickness thereof is from 30 to 100, preferably from 50 to 90 μm.

20. Use of the tubular film according to any of claims 1 to 19 for the packaging of meat, meat with bones, and paste-like foodstuffs.

21. A bag, characterized in that the bag is produced from a tubular film according to any of claims 1 to 19 by welding or sealing of the inner layer on itself.

22. Use of a bag produced according to claim 21 for the packaging of paste-like foodstuffs, meat, or meat with bones.
